(19) United States
(12) Patent Application Publication
(10) Pub. No.: US 2025/0158311 A1
(43) Pub. Date: May 15, 2025

(54) ELECTRICAL HIGH-VOLTAGE CONNECTOR AND METHOD FOR MOUNTING AN ELECTRICAL HIGH-VOLTAGE CONNECTION

(71) Applicant: TE Connectivity Solutions GmbH, Schaffhausen (CH)

(72) Inventors: Marcus WOLF, Bensheim (DE); Maik SCHAEFER, Bensheim (DE); Bjoern HOFFMANN, Bensheim (DE); Jens HUBER, Bensheim (DE); Manuel EHEIM, Bensheim (DE)

(21) Appl. No.: 18/944,200

(22) Filed: Nov. 12, 2024

(30) Foreign Application Priority Data
Nov. 13, 2023 (DE) 102023131516.1

(51) Int. Cl. H01R 13/42; H01R 43/20

(52) U.S. Cl. CPC H01R 13/42; H01R 43/20; H01R 2201/26

(57) ABSTRACT

An electric high-voltage connector for an electric high-voltage entity, such as a battery for a vehicle having an electric traction motor, includes a terminal receptacle, on/in which at least one or a plurality of electrical entity terminals of the high voltage entity are/can be arranged and a connector interface which can be provided on the terminal receptacle, in which at least one or a plurality of electrical interface terminals extending in an axial direction of the high-voltage connector are arranged, wherein the high-voltage connector has at least one positioning device divided over the terminal receptacle and the connector interface, by means of which the connector interface and the terminal receptacle are/can be mutually positioned with respect to a wall of the high-voltage entity.

### CROSS REFERENCE TO RELATED APPLICATIONS

This application claims the benefit of DE Application No. 102023131516.1, filed 13-Nov-2023, the subject matter of which is herein incorporated by reference in its entirety.

### BACKGROUND OF THE INVENTION

The subject matter herein relates generally to an electrical high-voltage connector, in particular an electrical high-voltage attached connector, for an electrical high-voltage entity, in particular a battery. The subject matter herein also relates generally to a method for mounting an electrical high-voltage connection to an electrical high-voltage entity, in particular a battery. Furthermore, the subject matter herein relates generally to an electrical high-voltage entity, in particular a battery, a traction battery or an inverter.

In the electrical sector (electrics, electrical engineering, electrical power engineering, etc.), a large number of electrical high-voltage connectors are known. These are used to transmit electrical voltages in the high-voltage range (high voltages: AC voltages over 24 V up to over 1 kV, DC voltages over 48 V up to over 1.5 kV), electrical currents in the high-current range (high currents over 25 A up to over 1 kA) and/or electrical powers in the high-power range (high powers of from 20 kW up to over 350 kW). In this case, the high-voltage connectors, for supplying and/or distributing electrical energy in cold, warm, possibly hot, contaminated, humid and/or chemically aggressive environments, must ensure problem-free transmission both in the short term and/or permanently.

Owing to a wide range of applications, aside from ground-based power engineering and its analogues, a large number of such high-voltage connectors are known in the automotive sector and in the non-automotive sector. In the automotive sector, such a high-voltage connector is suitable, for example, for electrically connecting a high-voltage and/or high-current line to a corresponding electrical high-voltage entity or vice versa, for connecting electrical high-voltage and/or high-current lines, or for a different type of electromechanical high-voltage and/or high-current contact connection. In this specification, the term “high-voltage” is intended to encompass the terms high-voltage, high-current and/or high-power (cf. above).

High costs for fossil fuels and efforts to reduce environmental impacts make, for example in the automotive sector, hybrid or electric vehicles necessary. One aspect of these vehicles is handling of high electrical charging and operating voltages and high electrical charging and operating currents, wherein the components in question of the vehicles need to be designed correspondingly. This applies in particular to high-voltage and/or high-voltage conductors (e.g. stranded wires, busbars, etc.) as well as the relevant high-voltage and/or high-current terminals (e.g. connecting pieces, flat contacts, busbars, etc.) and thus also the high-voltage connectors.

If a high-voltage connector is positioned on a high-voltage cable, reference is also made to a flying high-voltage plug connector or a high-voltage coupling. If a high-voltage connector is positioned on/in an electrical high-voltage entity (see below), for example a portion of a housing thereof, reference is also made to a high-voltage attached connector (uniquely with high-voltage attached connector). In the context of electrical power engineering (generating, converting, storing and transporting high-voltage electrical current in electricity grids, preferably with three-phase high-voltage transmission), owing to their complex structure reference is conversely made to cable accessories.

Efforts are continually being made to improve electrical high-voltage connectors. Particularly for the next generation of electromobility, it is desired to be able to establish electrical high-voltage connections, for example by and/or with a high-voltage connector, in particular a high-voltage attached connector, for example for a traction battery (traction battery interface) of a vehicle, in a rapid, simple and reliable manner.

### BRIEF DESCRIPTION OF THE INVENTION

In an embodiment, a high-voltage connector is provided, in particular a high-voltage attached connector, for a high-voltage entity, such as for a vehicle with an electric traction motor.

One or more aspects of the subject matter herein is achieved by means of an electrical high-voltage connector, in particular an electrical high-voltage attached connector, for an electric high-voltage entity, in particular a battery; by means of a method for mounting an electrical high-voltage connection to an electrical high-voltage entity, in particular a battery; and by means of an electrical high-voltage entity, in particular a battery, a traction battery or an inverter; in particular for a vehicle with an electric traction motor in each case.—Advantageous developments, additional features and/or advantages of the invention can be gleaned from the dependent claims and the following description.

The high-voltage connector according to the subject matter herein includes a mechanical terminal receptacle, on/in which at least one or a plurality of electrical entity terminals of the high-voltage entity are or can be arranged, in particular are or can be fixed; and an electro-mechanical connector interface, which can be provided on the terminal receptacle and in which at least one or a plurality of electrical interface terminals, extending in an axial direction of the high-voltage connector, are arranged, in particular fixed. The high-voltage connector has at least one positioning device divided over the terminal receptacle and the connector interface, by means of which the connector interface and the terminal receptacle are/can be mutually positioned with respect to a wall of the high-voltage entity, for example substantially parallel or angled thereto.

Here, the axial direction is arranged at an angle, in particular a right angle, to the (later) wall, e.g. of an entity housing, on/in the high voltage entity. The wall may be flat and/or curved in a relevant mounting region for the high-voltage connector. Here, of course, a relevant surface or a relevant section of the high-voltage connector, in particular of the interface housing and, optionally, the terminal receptacle, is correspondingly designed.

For example, a single entity terminal can be plugged into, clipped in and/or locked into a single receptacle of the terminal receptacle.—The high-voltage connector may, for example, be in the form of an interface, a plug, a socket, a coupling, an outlet, a flying connector, etc. In this case, the high-voltage connector can be designed as a high-voltage attached connector, in particular as a battery interface, a traction battery interface or an inverter interface. In this specification, the term “attached” shall include the term “built-in”.

By means of the positioning device, the terminal receptacle and the connector interface are only mutually positionable/positioned. Further, by means of the positioning device, the high-voltage connector or the terminal receptacle and the connector interface are not/cannot be intentionally positioned in the axial direction. Furthermore, the position of the high-voltage connector or the connector interface in the axial direction is/can be ensured by means of a third component, in particular the wall, of the high-voltage entity. In this case, the third component may be designed as an external component with respect to the high-voltage connector.

The positioning device may comprise a positioning means of the terminal receptacle and a positioning means of the connector interface.—The mutually related positioning means may be designed such that an intentionally configurable/configured mounting tolerance of the terminal receptacle relative with respect to the connector interface, in at least one bidirectional spatial direction, is/can be reduced to a line (freedom of movement, (generous) play; two translational degrees of freedom in this spatial direction) or substantially eliminated (fit, in particular clearance fit, transition fit; no translational degree of freedom in this spatial direction).

Furthermore, the mutually related positioning means may be designed in such a way that an intentionally configurable/configured mounting tolerance of the terminal receptacle relative to the connector interface in a first bidirectional spatial direction is/can be substantially eliminated (see above) and in a second bidirectional spatial direction can be reduced to a line (see above).—It is also preferred that a mounting tolerance of the terminal receptacle in relation to the connector interface in a third spatial direction (e.g. the axial direction) due to the high-voltage connector itself is not intended, or is limited to only a single direction (see FIG. 4).

By means of mutually related positioning means of the positioning device, a mutual freedom of movement of the terminal receptacle and connector interface due to an intentionally configurable/configured mounting tolerance: is/can be substantially eliminated in a first spatial dimension (see above), is/can be arranged along a line in a second spatial dimension (see above), and/or be unintentionally configurable/configured in a third spatial dimension. The spatial dimensions include an angle, in particular a substantially right angle.

The high-voltage connector can comprise exactly or at least one, two, three or four positioning devices for the correct positioning of the terminal receptacle and connector interface. Furthermore, at least two positioning devices are substantially identical and are ideally convertible into each other preferably by means of a translational and/or a rotational displacement. Exactly one translational and/or exactly one rotational ideal displacement is preferred.

A single positioning device may comprise a funnel as a first positioning means and a spigot as a second positioning means. The funnel and the spigot can be mutually coordinated such that the spigot can be moved back and forth in the funnel in a first bidirectional direction and is/can be arranged to be substantially immobile in a second bidirectional direction.—In principle, it is of course possible to provide a funnel on/in the terminal receptacle or on/in the connector interface, and vice versa a spigot on the connector interface or on the terminal receptacle. In the case of a plurality of positioning devices, of course, both the terminal receptacle and the connector interface can have at least one spigot each and at least one funnel each.

The terminal receptacle and the connector interface can be mutually designed for mounting the high-voltage connector on/in the high-voltage entity, in such a way that a fastening means, in particular a clamping screw, of the high-voltage connector coming from one side of the terminal receptacle, the entity terminals and/or the high-voltage entity, is/can be moved forward into the high-voltage connector. By means of a fastening means, preferably by bypassing the terminal receptacle (through-cutout in the terminal receptacle) an entity terminal is/can be fixed, in particular directly, to an interface terminal.

The clamping screw of the high-voltage connector may have a rotatable screw head, which is electrically insulated. Here, the screw head may be embedded in the electrical insulation, e.g. comprising a plastic. In one embodiment, the screw head has no electromagnetic shielding and/or no seal. The clamping screw can have a screw base which does not comprise any electrical insulation, in particular no protection against contact.

The terminal holder for the entity terminals of the high-voltage entity may have individual receptacles set apart from one another, which are arranged, for example, side by side in a line or in two dimensions. As a result, the longitudinal end portions of the entity terminals can be arranged substantially in a plane. A single receptacle may comprise at least one, preferably a plurality, of latching devices for locking the entity terminal relating thereto in place. Furthermore, a single receptacle may have a through-cutout, the diameter of which is preferably greater than a largest diameter of the fastening means. This can, for example, allow the screw head to engage with the relevant entity terminal directly. And the positioning means can be moulded into the terminal receptacle and/or moulded onto the terminal receptacle.

The connector interface can comprise an interface housing with domes in which at least sections of the interface terminals are arranged. The interface housing can have a circumferential seal, by means of which the interface housing is/can be sealed against the wall of the high-voltage entity. A seal may be arranged between the respective interface terminal and a terminal chamber of the connector interface. And the positioning means may be moulded to the connector interface and/or moulded into the connector interface.

The terminal receptacle and/or the interface housing may be integrally designed. An integral design is understood to mean a design of the relevant component (terminal receptacle or interface housing) in which there is only one single component part, which can be separated only by being destroyed. The component is manufactured from a single original piece and/or from a single original mass (plastic melt), which in turn is inevitably integral. An internal bond is formed (exclusively) by means of adhesion and/or cohesion. In this case, there may also be a coating, etc., present.

In the method according to the subject matter herein, in a first step at least one or a plurality of electrical entity terminals of the high-voltage entity are arranged, in particular fixed, on/in a terminal receptacle; and an electro-mechanical connector interface, in which at least one or a plurality of electrical interface terminals extending in an axial direction of the high-voltage connector are arranged, in particular fixed, is provided on the terminal receptacle. In a second step, preferably substantially immediately following the first step, first fastening means, in particular clamping screws, of the high-voltage connector coming from a lower side of the entity terminals adjacent to the high-voltage entity, are moved forward into the high-voltage connector and fixed into/onto the interface terminals. An electrical contact connection between the entity terminals and the interface terminals is established.

In a third step, which follows the third step, second fastening means, in particular second clamping screws, of a second high-voltage entity coming from an upper side of the entity terminals (also a top or a mating face of the connector interface) can be moved forward into the high-voltage connector and fixed in/on the interface terminals. An electrical contact connection of the interface terminals to entity terminals of the second high-voltage entity is established. The second high-voltage entity can be formed, for example, as an electrical high-voltage line (e.g. rigid or (conditionally) flexible) with an electrical high-voltage connector which comprises the second fastening means. A different design of the second high-voltage entity (see below) is of course possible.

In this case, the third step of the mounting method can be carried out a long time after the second step of the mounting method. In particular, it is possible to perform the third step in a separate location from the second step. For example, it is possible to perform the first two steps at a manufacturer of the high-voltage electrical entity, whereas the third step is only performed at a customer of this manufacturer.

In the first step of the mounting method, the at least one or the plurality of entity terminals can be plugged into the terminal receptacle, clipped and/or locked in place in the terminal receptacle. For this purpose, the terminal receptacle may have one single receptacle for each individual entity terminal. Further, in the first step at least one positioning means of the terminal receptacle can be received in/on at least one positioning means of the connector interface. In this case, the related positioning means can mutually centre themselves (conditionally), wherein a centring in a first direction can produce a more central result than a centring in a second direction, for example perpendicular to the first. Furthermore, in the first step, the terminal receptacle and the connector interface can be mutually positioned automatically with respect to a wall, e.g. of the entity housing, of the high-voltage entity using the positioning means.

In the second step of the mounting method, the first fastening means can be first moved forward on the base side through the terminal receptacle and/or the entity terminals to the interface terminals of the connector interface. Directly thereafter, by fixing the first fastening means in/on the interface terminals, the resulting high-voltage connector is mounted, e.g. on the wall e.g. of the entity housing. The entity terminals electrically contact the interface terminals.

In the mounting method, the first fastening means and the second fastening means can be moved forward from substantially opposite sides into the connector interface and fixed therein, in particular on/in the interface terminals.—In this case, at least the terminal receptacle, the connector interface and the first fastening means can be designed as a high-voltage connector according to the subject matter herein (see above).

An electrical entity high-voltage connection according to the subject matter herein on/in the high-voltage entity comprises a high-voltage connector according to the subject matter herein and at least one or a plurality of electrical entity terminals of the high-voltage entity. The entity terminals are permanently connected at their longitudinal end portions to the interface terminals of the high-voltage connector, for which purpose the fastening means extend through mounting through-cutouts in the longitudinal end portions of the entity terminals. Here, the entity high-voltage connection can be a component of the electrical high-voltage connection according to the subject matter herein.

To compensate for a tolerance, the mounting through-cutouts in the longitudinal end portions can be formed as slotted holes. A longitudinal extension of the respective slotted hole is substantially parallel to the (second) bidirectional spatial direction in which the terminal receptacle and the connector interface can be mutually moved back and forth; in particular, in which a spigot is/can be arranged in its funnel so as to be (significantly) moveable back and forth.

The electrical high-voltage entity according to the subject matter herein comprises a power-electric device and an electrical high-voltage connector for the power-electric device, wherein the high-voltage connector is designed as a high-voltage connector according to the subject matter herein and/or is mounted on the high-voltage entity by means of a mounting method according to the subject matter herein.—Such a high-voltage entity can e.g. also be (see above) in the form of an electrical component, an electrical module, an electrical unit, an electrical instrument, an electrical appliance, an electrical installation etc.

A vehicle—in particular a motor vehicle (road vehicle, utility vehicle, etc.), but also: rail vehicle, watercraft and/or aircraft—with an electric traction motor is understood to mean a motor vehicle which, in addition to an electric traction motor, may comprise a further non-electric drive, such as an internal combustion engine. That is to say a vehicle with an electric traction motor can be understood to mean, for example, an electric vehicle (electromotive drive only), a hybrid electric vehicle, a fuel cell vehicle, etc.

The invention is explained in greater detail below on the basis of exemplary embodiments with reference to the appended schematic drawings which are not to scale. Portions, elements, component parts, units, components and/or diagrams which have an identical, unique or analogous configuration and/or function are denoted by the same reference designations in the description of the figures (see below), the list of reference designations, the patent claims and in the figures (figs) of the drawing. A possible alternative which is not explained in the description of the invention (see above), is not illustrated in the drawing and/or is not definitive, a static and/or kinematic reversal, a combination etc., with respect to the exemplary embodiments of the invention or a component, a diagram, a unit, a component part, an element or a portion thereof, can also be gathered from the list of reference designations and/or the description of the figures.

In the case of the invention, a feature (portion, element, component part, unit, component, function, variable etc.) can be of positive configuration, that is to say present, or of negative configuration, that is to say absent. In this specification (description (description of the invention (see above), description of the figures (see below)), list of reference designations, patent claims, drawing), a negative feature is not explained explicitly as a feature if value is not placed on it being absent according to the invention. That is to say, the invention which is actually made and not an invention constructed by way of the prior art consists in omitting said feature.

A feature of this specification can be used not only in a specified manner and/or way, but rather also in another manner and/or way (isolation, combination, replacement, addition, on its own, omission, etc.). In particular, it is possible, in the description, the list of reference designations, the patent claims and/or the drawing, to replace, add or omit a feature in the patent claims and/or the description on the basis of a reference designation and a feature which is assigned to it, or vice versa. Furthermore, a feature in a patent claim can be interpreted and/or specified in greater detail as a result.

The features of the description can also be interpreted as optional features (in view of the (initially mostly unknown) prior art); that is to say, each feature can be considered to be an optional, arbitrary or preferred feature, that is to say a feature which is not mandatory. Therefore, a separation of a feature, possibly including its periphery, from an exemplary embodiment is possible, it then being possible for said feature to be transferred to a generalized inventive concept. The absence of a feature (negative feature) in an exemplary embodiment shows that the feature is optional as appropriate in relation to the invention (person skilled in the art). In addition, in the case of a type term for a feature, a generic term for the feature can also be implicitly understood (possibly further hierarchical breakdown into subgenus, etc.), as a result of which a generalization of the feature is possible, for example with consideration of equivalent effect and/or equivalence.

### BRIEF DESCRIPTION OF THE DRAWINGS

In the merely exemplary and schematic figures of the drawing:

FIGS. 1 and 2 show schematic representations of a first embodiment of an electrical high-voltage connector according to the subject matter herein in a two-dimensional longitudinal side view (FIG. 1, plane Ar-Lr) and a perspective frontal view (FIG. 2, essentially plane Ar-Qr), and

FIGS. 3-5 show a second embodiment of the high-voltage connector in a perspective longitudinal side view (FIG. 3, essentially plane Ar-Lr), a perspective frontally cut corner view (FIG. 4) and a centrally cut two-dimensional longitudinal side view (FIG. 5, plane Ar-Lr).

### DETAILED DESCRIPTION OF THE INVENTION

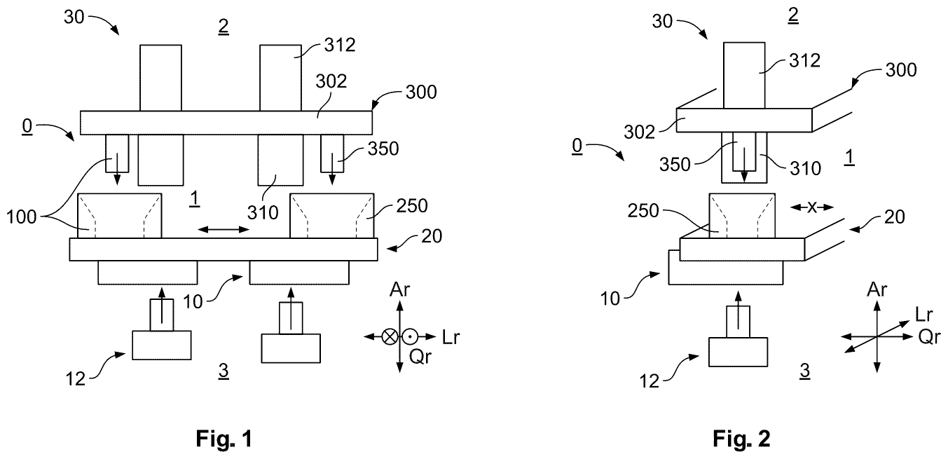

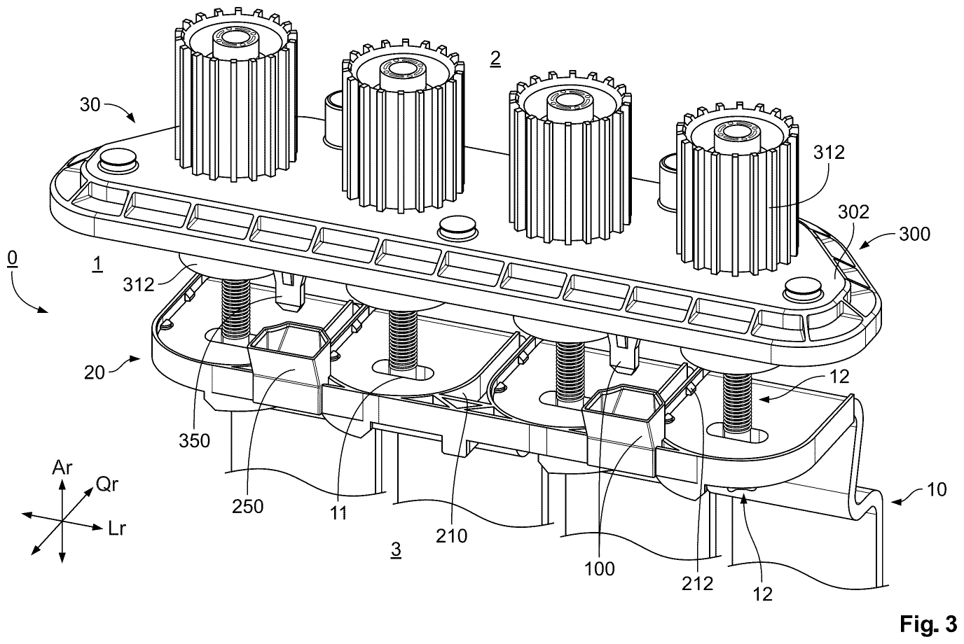

The subject matter herein is explained in greater detail below on the basis of exemplary embodiments of two embodiments (first embodiment: FIGS. 1 and 2, second embodiment: FIGS. 3 to 5) of an electrical high-voltage connector 1, in particular a high-voltage attached connector 1 (high-voltage attached connector 1), for an electrical high-voltage entity 0, preferably for a vehicle with an electric traction motor. The subject matter herein is of course also applicable to other electrical connectors, in particular high-voltage connectors 0. In this case the high-voltage connector 0 can, for example, be in the form of an interface, a plug, a socket, a coupling, an outlet, a flying connector, etc.

Although the invention is described and illustrated further in greater detail by way of preferred exemplary embodiments, the invention is not restricted by the disclosed exemplary embodiments, but rather is of a more fundamental nature. Other variations can be derived therefrom and/or from the above (description of the invention), without departing from the scope of protection of the invention. The invention can be used in general in the electrical sector, that is to say also in the non-automotive sector, in the case of an electrical entity or high-voltage entity (cf. above). One exception is ground-based electrical power engineering and its analogues.

The drawing shows only those physical portions of subject matter of the invention which are necessary for understanding the invention. Designations such as connector and mating connector, terminal and mating terminal etc. are to be interpreted synonymously, that is to say may be mutually interchangeable. The explanation of the invention (see also above) based on the drawing refers below, inter alia, to a (bi-directional) transverse direction Qr (also referred to as (first) spatial dimension/direction Qr), a (bi-directional) longitudinal direction Lr (also referred to as (second) spatial dimension/direction Lr), and to a (bidirectional) axial direction Ar or vertical direction Ar (also referred to as (third) spatial dimension/direction Ar) of the high-voltage connector 1.

FIGS. 1 and 2 and FIGS. 3 to 5 each show an embodiment of the high-voltage connector 1, wherein the actual high-voltage connector 1 solely comprises: a preferably single, exclusively mechanical terminal receptacle 20; a preferably single, electromechanical connector interface 30 and at least one or a plurality of fastening means 12, in particular (high-voltage connection) clamping screws 12. The terminal receptacle 20 and the connector interface 30 can be mounted on/in the high voltage entity 0 as high-voltage connector 1 by means of the fastening means 12.

In this case, the connector interface 30 comprises electrical interface terminals 310 in an interface housing 300, wherein the first embodiment has two interface terminals 310 and two fastening means 12 for the connector interface 30, and the second embodiment has four interface terminals 310 and four fastening means 12 for the connector interface 30.—The respective interface terminal 310 is arranged in a terminal chamber 314 of the connector interface 30, in particular in a fixed position and preferably sealed, and can be designed in particular as a sleeve 310, which is electrically contactable at its two longitudinal ends and/or longitudinal end portions.

The interface housing 300 may have domes 312, in which the interface terminals 310 are at least partially arranged. The domes 312 form a portion of a mating face 2 of the high-voltage connector 1 and are accessible at their free longitudinal end portions for an electrical high-voltage mating connector (not shown), which with its electrical mating terminals can electrically contact the interface terminals 310 located in the domes 312. For this purpose, the mating terminals can be screwed to the interface terminals 310. Any other mechanical connection, such as a plug connection, is of course applicable.

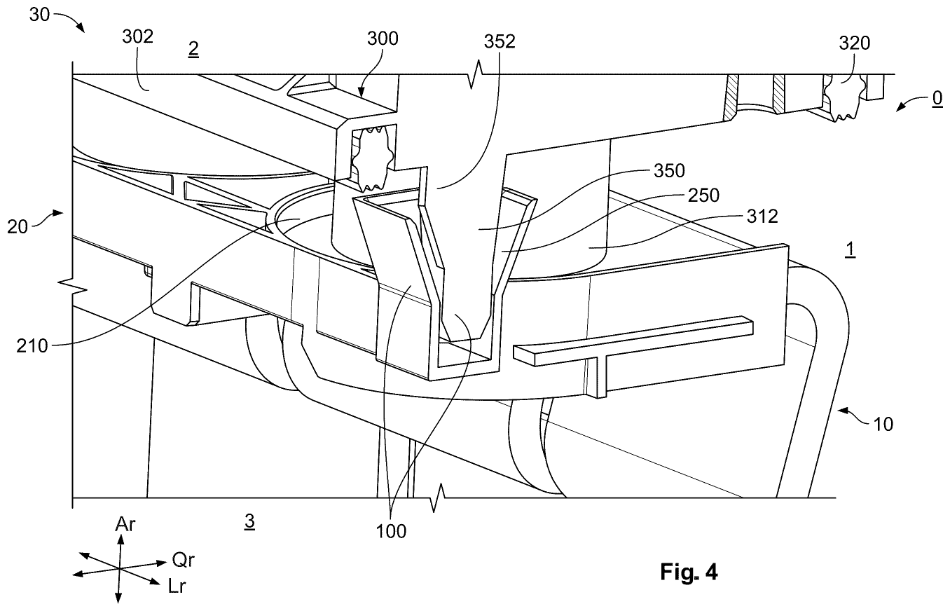

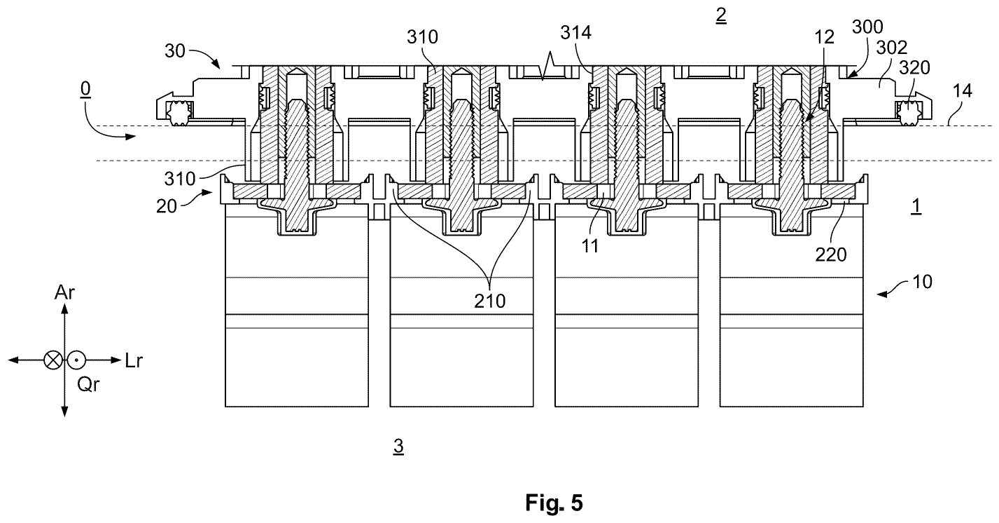

The interface housing 300 further preferably comprises a housing base 302, from which the domes 312 protrude on one side. By means of the housing base 302, the high-voltage connector 1 can be attached to a wall 14, e.g. a wall 14 of a housing of the high-voltage entity 0. In this case, the interface housing 300, in particular with its housing base 302, is sealed to the wall 14, for which purpose the housing base 302 preferably has a seal 320 arranged with respect to the wall 14 (see FIGS. 4 and 5).

The domes 312 of the interface housing 300 may extend through the housing base 302 as far as an opposite side of the housing base 302 (second embodiment). These sections of the dome 312 protrude into high-voltage connector 1, or through the wall 14, with the high-voltage connector 1 in a mounted state. On this side (bottom), the domes 312 are open and the interface terminals 310 located there can be electrically contacted by the entity terminals 10.

For such an electrical contact connection, a respective free longitudinal end of an interface terminal 310 is seated on a free longitudinal portion of an entity terminal 10. The mutually related surfaces of the interface terminal 310 and of the entity terminal 10 extend in longitudinal direction Lr and transverse direction Qr (electrical contact plane) respectively. In this case, a free end of an interface terminal 310 is slightly further below a free end of a related dome 312 in the direction of the high voltage entity 1, so that the dome 312 does not obstruct or prevent the electrical contact.

In order that the at least one or the plurality of interface terminals 310 can electrically contact an identical number of entity terminals 10, this number of entity terminals 10 can be arranged on/in the terminal receptacle 20, and/or configured for mounting the high-voltage connector 1 and thus also in the installed state of the high-voltage connector 1. Such an entity terminal 10 is preferably designed as a busbar 10 or a connection piece 10, but can of course also be designed in other ways.—In the present case, the entity terminals 10 are angled, optionally in multiple ways, (approx. right angle) at their free longitudinal end regions; other configurations are of course applicable.

A single entity terminal 10 extends, apart from an extension in its thickness direction (axial direction Ar), in the present case at its free longitudinal end portion in transverse direction Qr and longitudinal direction Lr and has a substantially u-shaped or rectangular outer contour. A different outer contour is of course applicable. Each one of these free longitudinal end portions can be provided in an individual receptacle 210 of the terminal receptacle 20 formed complementary thereto, in particular can be plugged in, clipped in and/or locked in place. That is, the terminal receptacle 20 has preferably one individual receptacle 210 for each entity terminal 10.

In the present case, a longitudinal end portion of a single entity terminal 10 can be inserted into its individual receptacle 210 in transverse direction Qr underneath lateral latching devices 212 and can thus be locked in place in the individual receptacle 210 in an axial direction Ar. Alternatively, a longitudinal end portion of a single entity terminal 10 can be plugged into its individual receptacle 210 in axial direction Ar under elastic compression of the latching devices 212 and can thus be locked in place in the individual receptacle 210 in an axial direction Ar. A base or a base wall of the individual receptacle 210 prevents movement of a single entity terminal 10 in the other axial direction Ar.

In particular, the related individual receptacle 210 prevents movement of its entity terminal 10 in both longitudinal directions Lr and at least one transverse direction Qr. The remaining possibility of movement in the remaining transverse direction Qr for a complete locking of the entity terminal 10 in place in the respective individual receptacle 210 can be carried out, for example, by locking a surface of the longitudinal end portion of the entity terminal 10 with the floor wall of the individual receptacle 210.

In the present case, the terminal receptacle 20 has individual receptacles 210 set apart from one another, which are arranged in a line. Of course, a two-dimensional arrangement (i.e. an array of the individual receptacles 210 in two preferably mutually perpendicular lines) of the individual receptacles 210 is also possible. In addition, the individual receptacles 210 do not need to be set apart from one other, but this may be helpful for locking the entity terminals 10 in place in the individual receptacles 210.

The floor wall of a given individual receptacle 210 has a through-cutout 220 for at least a partial penetration of the respective fastening means 12. Preferably, the through-cutout 220 is dimensioned such that the fastening means 12 can be pushed completely through it. This means, for example, that a head of a fastening means 12 designed as a screw 12 can be attached directly to the (underside of the) entity terminal 10 and this does not have to clamp over the floor wall of the individual receptacle 210.

In the state in which the high voltage connector 1 is mounted on/in the high voltage entity 0, the connector electrically connects the entity terminals 10 of a power-electrical device 3 of the high voltage entity 0 to the interface terminals 310 of the high voltage connector 1 (entity high voltage connection). This makes the high-voltage entity 0 electrically contactable by a high-voltage mating connector via its high-voltage connector 1. For the mounting of the high-voltage connector 1, the wall 14, e.g. of the housing of the high-voltage entity 0, is received between the terminal receptacle 20 (including the entity terminals 10 provided therein) and the connector interface 30.

When mounting the high-voltage connector 1, the connector interface 30 can be provided on the terminal receptacle 20, with its longitudinal end portions of the entity terminals 10 arranged thereon/therein, and/or vice versa. For mutual positioning of connector interface 30 and terminal receptacle 20, the high-voltage connector 1 has a positioning device 100; 250, 350, which is divided over the terminal receptacle 20 and the connector interface 30, or is realized by means of the terminal receptacle 20 and the connector interface 30. That is, the positioning device 100; 250, 350 of the high-voltage connector 1 mutually positions the connector interface 30 and the terminal receptacle 20 as a high-voltage connector 1.

Apart from an angle of inclination relative to a mounting plane, which in the present case is defined by the transverse direction Qr and the longitudinal direction Lr, the connector interface 30 and the terminal receptacle 20 can be mutually positioned by means of the positioning device 100; 250, 350, or are positioned in the mounted state of the high-voltage connector 1. In this case, the wall 14 of the high voltage entity 0 is located between the connector interface 30 and the terminal receptacle 20.

The positioning device 100; 250, 350 positions the connector interface 30 and the terminal receptacle 20 mutually in the transverse direction Qr and longitudinal direction Lr with respect to the wall 14 which is/can be accommodated between them. In the mounted state, the wall 14 positions the high-voltage connector 1 or the connector interface 30 and the terminal receptacle 20 in the axial direction Ar.

The positioning device 100; 250, 350 comprises, in each case at least: a single positioning means 250 of the terminal receptacle 20 and a single positioning means 350 of the connector interface 30. Preferably, the terminal receptacle 20 and the connector interface 30 each have more than a single positioning means 250, 350, in particular exactly or at least: two, three or four positioning means 250, 350.

The positioning device 100, or two positioning means 250, 350 that interact or are able to interact, can be designed in such a way that a mutual mounting tolerance of the connector interface 30 relative to the terminal receptacle 20 can be reduced to a line in the transverse direction Qr and preferably substantially eliminated (apart from a clearance) in the longitudinal direction Lr. For this purpose, the entity terminals 10 have a corresponding design, in particular a corresponding design of their mounting through-cutouts 11 (see below).—This can of course be arranged vice versa or relate to other directions that do not have to be perpendicular to each other.

That is, the connector interface 30 and the terminal receptacle 20 are movable relative to each other along a line in the longitudinal direction Lr, and in the transverse direction Qr, apart from a necessary clearance, are preferably substantially immovable relative to each other in the high-voltage connector 1. For this purpose, the positioning device 100; 250, 350 or the interacting/able to interact positioning means 250, 350 are designed accordingly; i.e. they permit the conditional mobility in the longitudinal direction Lr and preferably the conditional immobility in the transverse direction Qr.

For this purpose, one positioning means 250 can be designed as a funnel 250 and one positioning means 350 as a spigot 350, wherein the spigot 350 is received in the funnel 250 during and after mounting, and according to the above, the funnel 250 restricts the possibility of movement of the spigot 350 in the funnel 250. Such a funnel 350 may be open or closed at one end of its funnel neck.—In the present case, the funnel 250 is arranged on/in the terminal receptacle 20 and the spigot 350 is arranged on the connector interface 30. Of course, this can be implemented in reverse or even in a mixed form.

Furthermore, a different configuration of the positioning device 100 or the interacting/able to interact positioning means 250, 350 is of course possible. For example, it is possible to form the funnels 250 not as complete funnels 250 but as open funnels, which together realize the function of one or a plurality of funnels intended here. Furthermore, a cone-shaped portion of a funnel can also be omitted and this can be realized simply by its funnel neck, i.e. by a (through-)cutout, which can have, for example, an insertion aid designed as a bevel.

In the present case, both a funnel 250 and a spigot 350 have mainly rectangular cross-sections, wherein the rectangular, optionally the square, cross-section of a spigot 350 is received in the rectangular cross-section of a funnel 250. In this case, the rectangular cross-section of the spigot 350 can be received in the rectangular cross-section of the funnel 250 such that it can move back and forth in the longitudinal direction Lr. And in a substantially perpendicular direction thereto (transverse direction Qr), the rectangular cross-section of the spigot 350, apart from any necessary play, is received substantially immovably in the rectangular cross-section of the funnel 250.

Analogous to its rectangular cross-sections in a funnel neck, the funnel 250 in its conical portion preferably also comprises rectangular cross-sections, which increase in size starting from the actual terminal receptacle 20 (upwards) in the direction of the connector interface 30. A different shape of a conical portion of the funnel 250 is of course possible. In general, the cross-sectional shapes of the conical portion of the funnel 250 will be similar to the cross-sectional shapes of the funnel neck of the funnel 250.

Of course, other cross-sections of the funnel 250 and the spigot 350 are applicable, of course only provided they meet the mutual movement requirements of terminal receptacle 20 and connector interface 30. Such cross-sections are, for example, circular, elliptical, oval, polygonal or composite cross-sections. Here again, the function of the cone-shaped portion of the funnel 250 can be fulfilled by a bevel of the funnel neck.

The terminal receptacle 20 and the connector interface 30 and/or the respective funnel 250 and the respective spigot 350 are preferably designed such that the spigot 350 cannot be completely inserted into the funnel 250. This means that a free end of the spigot 350 touches a base, if present, of the funnel 250 neither during nor after the mounting of the high-voltage connector 1 on/in the high-voltage entity 0. For this purpose, the respective spigot 350 may have a rib 352 (FIG. 4) or similar, which prevents the spigot 250 from moving too far forward into the funnel 350.

Preferably, the mounting through-cutouts 11 in the entity terminals 10 are formed as slotted holes 11, wherein a longitudinal extension of the respective slotted hole 11 extends in the longitudinal direction Lr and a diameter of the slotted hole 11 extends in the transverse direction Qr. It is preferred here that an extension of the slotted hole 11 in the longitudinal direction Lr is slightly shorter, approximately the same length or slightly longer than an extension of a cutout in the funnel neck of the funnel 250 in the longitudinal direction Lr. The diameter of the slotted hole 11 is selected in a preferably conventional manner with respect to the fastening means 12 (clearance).

Furthermore, in FIGS. 1 and 2 it is easy to see how the positioning means 250, 350 realize the mutual conditional mobility of the terminal receptacle 20 relative to the connector interface 30. In the longitudinal direction Lr (FIG. 1, dashed, double-headed arrow), an inner, free guide portion (negative) of the positioning means 250 is longer than the material positioning means 350 (positive). And in the transverse direction Qr (FIG. 2, dashed, X-ed out double-headed arrow), an inner, free guide portion (negative) of the positioning means 250 is approximately as wide as the material positioning means 350 (positive). Therefore, the positioning means 250 can move back and forth in the positioning means 350 substantially only in the longitudinal direction Lr.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. An electrical high-voltage connector for an electrical high-voltage entity comprising:
a terminal receptacle configured to receive at least one electrical entity terminal of the high-voltage entity, the terminal receptacle having a connector interface;
at least one electrical interface terminal received in the terminal receptacle, the at least one electrical interface terminal extending in an axial direction of the high-voltage connector; and
a positioning device divided over the terminal receptacle and the connector interface, the positioning device configured to mutually position the connector interface and the terminal receptacle with respect to a wall of the high-voltage entity.

2. Electrical high-voltage connector according to claim 1, wherein the positioning device is configured to only mutually position the terminal receptacle and the connector interface with respect to the wall of the high-voltage entity such that the terminal receptacle and the connector interface cannot be intentionally positioned in the axial direction, and wherein a position of the connector interface in the axial direction is configured to be position by a wall of the high-voltage entity.

3. Electrical high-voltage connector according to claim 1, wherein the positioning device comprises a positioning means of the terminal receptacle and a positioning means of the connector interface, wherein the mutually related positioning means are designed in such a way that an intentionally configured mounting tolerance of the terminal receptacle relative to the connector interface in at least one bidirectional spatial direction is reduced to a line segment.

4. Electrical high-voltage connector according to claim 1, wherein, by means of mutually related positioning means of the positioning device, a mutual freedom of movement of the terminal receptacle and the connector interface due to an intentionally configured mounting tolerance is substantially eliminated in a first spatial dimension, is arranged along a line segment in a second spatial dimension, and is unintentionally arranged in a third spatial dimension.

5. Electrical high-voltage connector according to claim 1, wherein the high-voltage connector, for the correct positioning of terminal receptacle and connector interface, comprises at least two positioning devices substantially identical and convertible into each other by at least one of a translational displacement and a rotational displacement.

6. Electrical high-voltage connector according to claim 1, wherein a single positioning device comprises a funnel as a first positioning means and a stud as a second positioning means, the funnel and the stud matching each other such that the stud is configured to be moved back and forth in the funnel in a first bidirectional direction and is configured to be substantially immoveable in a second bidirectional direction.

7. Electrical high-voltage connector according to claim 1, wherein the terminal receptacle and the connector interface for mounting the high-voltage connector at the high-voltage entity are mutually formed in such a way that a fastener of the high-voltage connector coming from one side of the terminal receptacle, the entity terminals and/or the high-voltage entity is moved forward into the high-voltage connector.

8. Electrical high-voltage connector according to claim 7, wherein the fastener includes a clamping screw, the clamping screw having a rotatable screw head and a screw base, the screw head being electrically insulated, the screw base does not contain an electrical insulation.

9. Electrical high-voltage connector according to claim 7, wherein the terminal receptacle for the entity terminals of the high-voltage entity has individual receptacles set apart from one another, each individual receptacle including a latching device configured for locking the entity terminal related thereto in place, each individual receptacle having a through-cutout, a diameter of the through-cutout being greater than a largest diameter of the fastening means.

10. Electrical high-voltage connector according to claim 1, wherein the connector interface includes an interface housing with domes in which at least portions of the interface terminals are arranged, the interface housing having a circumferential seal configured to be sealed against the wall of the high-voltage entity, a seal being arranged between the respective interface terminal and a terminal chamber of the connector interface.

11. Method for mounting an electrical high-voltage connection to an electrical high-voltage entity for a vehicle, the method comprising:
in a first step, arranging electrical entity terminals of the high-voltage entity in a terminal receptacle having a connector interface with electrical interface terminals extending in an axial direction of the high-voltage connector; and
in a second step following the first step, moving first fasteners of the high-voltage connector, coming from a lower side of the entity terminals adjacent to the high-voltage entity, forward into the high-voltage connector and fixing the first fasteners at the interface terminals.

12. Method according to claim 11, further comprising, in a third step following the second step, moving second fasteners of a second high-voltage entity, coming from an upper side of the entity terminals, forward into the high-voltage connector and fixing the second fasteners at the interface terminals.

13. Method according to claim 11, wherein the first fasteners and the second fasteners are advanced from substantially opposite sides into the connector interface and fixed therein.

14. Method according to claim 11, wherein, in the first step:
the entity terminals are plugged in, clipped into and/or latched in the terminal receptacle,
at least one positioning means of the terminal receptacle is received in/on at least one positioning means of the connector interface, and/or
the terminal receptacle and the connector interface position each other self-actingly with respect to a wall of the high-voltage entity by means of the positioning means.

15. Mounting method according to claim 1, wherein, in the second step, the first fastening means are initially advanced on the base side through the terminal receptacle and/or the entity terminals to the interface terminals of the connector interface.

16. Electrical high-voltage entity for a vehicle comprising:
a power-electric unit; and
an electrical high-voltage connector for the power-electric unit, the electric high-voltage connector comprising:
a terminal receptacle configured to receive at least one electrical entity terminal of the high-voltage entity, the terminal receptacle having a connector interface;
at least one electrical interface terminal received in the terminal receptacle, the at least one electrical interface terminal extending in an axial direction of the high-voltage connector; and
a positioning device divided over the terminal receptacle and the connector interface, the positioning device configured to mutually position the connector interface and the terminal receptacle with respect to a wall of the high-voltage entity.

17. Electrical high-voltage entity according to claim 16, wherein the terminal receptacle and the connector interface for mounting the high-voltage connector at the high-voltage entity are mutually formed in such a way that a fastener of the high-voltage connector coming from one side of the terminal receptacle, the entity terminals and/or the high-voltage entity is moved forward into the high-voltage connector.

18. Electrical high-voltage entity according to claim 16, wherein the positioning device is configured to only mutually position the terminal receptacle and the connector interface with respect to the wall of the high-voltage entity such that the terminal receptacle and the connector interface cannot be intentionally positioned in the axial direction, and wherein a position of the connector interface in the axial direction is configured to be position by a wall of the high-voltage entity.

19. Electrical high-voltage entity according to claim 16, wherein the positioning device comprises a positioning means of the terminal receptacle and a positioning means of the connector interface, wherein the mutually related positioning means are designed in such a way that an intentionally configured mounting tolerance of the terminal receptacle relative to the connector interface in at least one bidirectional spatial direction is reduced to a line segment.

20. Electrical high-voltage entity according to claim 16, wherein, by means of mutually related positioning means of the positioning device, a mutual freedom of movement of the terminal receptacle and the connector interface due to an intentionally configured mounting tolerance is substantially eliminated in a first spatial dimension, is arranged along a line segment in a second spatial dimension, and is unintentionally arranged in a third spatial dimension.
